(19) United States
(12) Patent Application Publication
(10) Pub. No.: US 2014/0324995 A1
(43) Pub. Date: Oct. 30, 2014

(54) NOTIFYING A PUBLIC USER IN INSTANT MESSAGING

(71) Applicant: Xiaolong Zhang, Shenzhen (CN)

(72) Inventor: Xiaolong Zhang, Shenzhen (CN)

(21) Appl. No.: 13/994,083

(22) PCT Filed: Apr. 27, 2013
(86) PCT No.: PCT/CN13/74891

§ 371 Date: Jun. 13, 2013

(51) Int. Cl. H04L 12/58

(52) U.S. Cl. CPC H04L 51/04
USPC 709/206

(57) ABSTRACT

In a method for notifying a public user in instant messaging, determining, by a client device of a private user, whether a conversation window is opened between the private user and a public user; and if the conversation window between the private user and public user is opened, notifying, by the client device of the private user, an IM server that the private user opens the conversation window with the public user, such that the IM server notifies the public user that the private user opens the conversation window with the public user.

### FIELD

The present disclosure relates to instant messaging techniques, and more specifically, to a method and an apparatus for notifying a public user in instant messaging.

### BACKGROUND

Instant Messaging (IM) is a form of communication over the Internet that offers quick transmission of messages from sender to receiver. It may address point-to-point communications as well as multicast communications from one sender to many receivers.

More advanced instant messaging allows enhanced modes of communication, such as live voice or video calling, video chat and inclusion of hyperlink to media.

At present, some instant messaging provides a public platform for users. Companies, brands and celebrities may register on the public platform to have a public account (or referred to as official account) to communicate with their customers and fans directly. For example, WeChat (Weixin) has released a public platform for users to register public account. After registering on the public platform, the user gets a public account. Through the public platform of WeChat, venders may sell stuff or send news update, discount voucher, campaign announcement to their customers (also referred to as private users) on WeChat. And customers (private users) may receive messages such as “wait”, “hold on a second”, “in this way” from venders.

### SUMMARY

Various examples of the present disclosure provide a method and an apparatus for notifying a public user in instant messaging.

According to one example of the present disclosure, a computer-implemented method for notifying a public user in instant messaging includes:

determining, by a client device of a private user, whether a conversation window is opened between the private user and a public user; and

if the conversation window between the private user and public user is opened, notifying, by the client device of the private user, an IM server that the private user opens the conversation window with the public user, such that the IM server notifies the public user that the private user opens the conversation window with the public user.

According to another example of the present disclosure, a computer-implemented method for notifying a public user in instant messaging includes:

receiving, by an IM server, a notification from a client device of a private user, wherein the notification indicates that the private user opens a conversation window with a public user; and

after receiving the notification, notifying, by the IM server, the public user that the private user opens the conversation window with the public user.

According to another example of the present disclosure, a client device of a private user in instant messaging includes: a processor and a memory coupled to the processor, wherein the memory includes machine readable instructions executable by the processor to:

determine whether a conversation window is opened between the private user and a public user; and

if the conversation window between the private user and public user is opened, notify an IM server that the private user opens the conversation window with the public user, such that the IM server notifies the public user that the private user opens the conversation window with the public user.

According to another example of the present disclosure, a non-transitory computer-readable storage medium storing one or more programs, which when being executed by a processor, perform the steps of:

determining whether a conversation window is opened between the private user and a public user; and

if the conversation window between the private user and public user is opened, notifying an IM server that the private user opens the conversation window with the public user, such that the IM server notifies the public user that the private user opens the conversation window with the public user.

The method and apparatus provided by various examples of the present disclosure beneficially allows a public user to aware of the open of the conversation window between the private user and the public user. Thus, the public user may transmit messages or provide services to the private user. The public user may provide a better service and the experience of the private user is improved.

The features and advantages described in the disclosure are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating a network computer system 100 for notifying a public user in accordance with an example of the present disclosure.

FIG. 2 is a block diagram illustrating a method for notifying a public user in accordance with an example of the present disclosure.

FIG. 3 is a block diagram illustrating a method for notifying a public user in accordance with an example of the present disclosure.

FIG. 4 is a block diagram illustrating a method for notifying a public user in accordance with an example of the present disclosure.

FIG. 5 is a block diagram illustrating a method for notifying a public user in accordance with an example of the present disclosure.

FIG. 6 is a flowchart illustrating a server 160 for notifying a public user in accordance with an example of the present disclosure.

FIG. 7 is a schematic diagram illustrating a client device 700 for notifying a public user in accordance with an example of the present disclosure.

### DETAILED DESCRIPTION

Hereinafter, the present disclosure will be described in further detail with reference to the accompanying drawings and examples to make the technical solution and merits therein clearer.

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

Aspects of the present disclosure are described herein with reference to flowchart illustrations and/or block diagrams of method, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable processing apparatus or other devices to produce a computer implemented process such that the instructions which execute on the computer or other programmable apparatus provided processes for implementing the functions/acts specified in the flowchart and/or block diagram block or blocks.

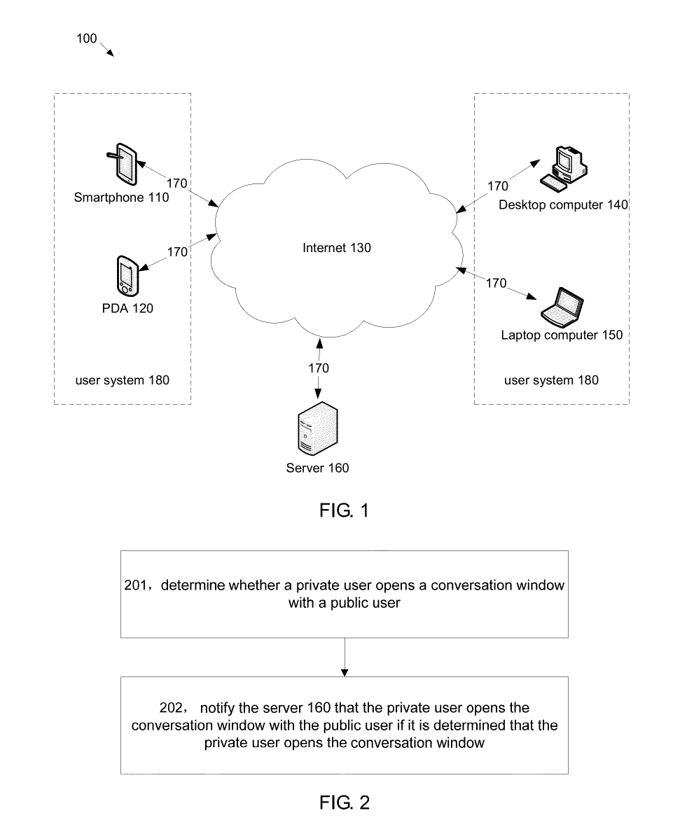

Referring now to FIG. 1, a network computer system 100 for notifying a public user in instant messaging in accordance with an example of the present disclosure comprises: a server 160; a user system 180; and the Internet 130. The user system 180 may include one or more client devices such as a smartphone 110, a Personal Digital Assistant 120, a desktop computer 140 and a laptop computer 150. Additionally, other devices such as netbooks, handheld and palmtop devices are also included in the description of client devices that may be deployed as a client device in user system 180.

All of the client devices in the user system 180 are connected or coupled via a link 170 to the Internet 130.

Smartphone 110, PDA 120, desktop computer 140 and laptop computer 150 include communication software to enable users to access the server 160. Typically, users of smartphone 110 and PDA 120 access the server 160 using an IM client application installed in the smartphone 110 and PDA 120. Users of the desktop computer 140 and laptop computer 150 may access the server 160 using an IM public platform provided by the server 160.

In various examples of the present disclosure, users accessing the server 160 using the IM client application installed in the client device may be referred to as private users. Users accessing the server 160 using an IM public platform provided by the server 160 may be referred to as public users or public accounts.

The server 160 may support IM services, i.e., allow users to send and receive IM messages. The server 160 may support other services related to IM.

To begin an IM session, a user may access the server 160 using an IM client application (for private users) or log on an IM public platform (for public users) and then exchanges IM messages with the particular buddies or participates in a group chat.

Link 170 represents any suitable communication link or similar communication mechanism including some combination of a hardwired connection, an internal or external bus, a connection for telephone access via radio, infrared or other wireless communication methodologies (i.e., “Wi-Fi” or “Wi-max”, “Bluetooth”, infrared, etc.), private or proprietary local area networks (LANs) and wide area networks (WANs), as well as standard computer network communications over Internet 130 or an internal network (e.g., “intranet”) via a wired or wireless connection, or any other suitable connection between computers and computer components known to those skilled in the art, whether currently known or developed in the future.

In addition to the other components shown in FIG. 1, a wireless communication access device may be communicatively coupled to link 170 and may be any wireless communication mechanism that is known to those skilled in the art to provide wireless communication between the Internet 130 and various devices associated with the Internet 130, including smartphone 110, PDA 120, desktop computer 140 as well as laptop computer 150. In various examples of the present disclosure, an acceptable wireless communication access device may comprise any type of wireless access point, wireless bridge, wireless router, or similar type of device (no shown in FIG. 1).

Server 160 in FIG. 1 represents a computer system that is made available to the client devices in the user system 180 via link 170 and the Internet 130. Various hardware components (not shown in FIG. 1) such as external monitors, keyboards, mice, tablets, hard disk drives, magnetic tapes, and other devices may be used in conjunction with server 160.

The server 160 may include a user profile server (not shown) connected to a database (not shown) for storing large amounts of user profile data. The user profile server may be used to enter, retrieve, edit, manipulate or otherwise process user profile data. In one implementation, a user's profile data includes, for example, user name, buddy list, geographic location, interests, etc. Users may enter, edit and/or delete profile data using the installed IM client application or through the public platform.

Server 160 may also provide various additional software components (not shown in FIG. 1) such as database servers, web servers, firewalls, security software, and the like. The use of these various hardware and software components is well known to those skilled in the art. In at least one preferred example, the server 160 is used to offer a “public platform” and other IM services.

Smartphone 110 and PDA 120 in the user system 180 are representatives of any type of cellular device or telephone that may be communicatively coupled to network computer system 100.

Desktop computer 140 in the user system 180 may be any type of computer system known to those skilled in the art that is capable of being configured for use with network computer system 100 as described herein. As previously explained in conjunction with server 160, various hardware components and software components (not shown in FIG. 1) known to those skilled in the art may be used in conjunction with desktop computer 140.

Similarly, laptop computer 150 in the user system 180 may be any type of portable computer system known to those skilled in the art that is capable of being configured for use with network computer system 100 as described herein.

In general, users of desktop computer 140 and laptop computer 150 may log on a “public platform” provided by the server 160 so as to receive IM services provided by the server 160. It should be noted that, public users may also access the Internet 130 via devices such as smartphone 110 and PDA 120, but not restricted to use the desktop computer 140 or laptop computer 150.

In various examples of the present disclosure, users of smartphone 110 and PDA 120 may access the Internet 130 via an IM application installed in the smartphone 110 and PDA 120. It should be noted that, private users may also access the Internet via the IM applications installed in devices such as desktop computer 140 or laptop computer 150.

Hereinafter, the method provided by various examples of the present disclosure will be described more fully with reference to the network computer system 100.

Referring now to FIG. 2, a block diagram of notifying a public user in instant messaging in accordance with an example of the present disclosure is depicted. The procedure of FIG. 2 may be implemented by various types of hardware, software, device, computer, computer system, equipment, component, program, application, code, storage medium, or propagated signal.

The method shown in FIG. 2 involves determining whether a private user opens a conversation window with a public user (block 201) and notifying the server 160 that the private user opens the conversation window with the public user if it is determined that the private user opens the conversation window (block 202). Thereafter, the server 160 may notifies the public user that the private user has opened a conversation window with the public user if the public user has real-time response ability. Then, the public user may take an action, e.g. send a message to the private user.

Hereinafter, the procedure of FIG. 2 will be described more fully with reference to several examples and the accompanying drawings.

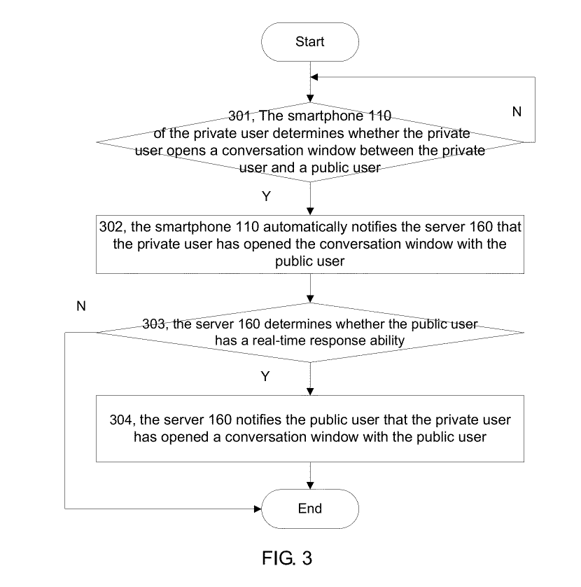

FIG. 3 is a schematic diagram illustrating a method for notifying a public user in instant messaging in accordance with an example of the present disclosure. It should be noted that some functions of the procedure shown in FIG. 3 are not necessarily essential for implementing the present disclosure.

As shown in FIG. 3, a private user will communicate with network computer system 100 shown in FIG. 1. Hereinafter, the user of smartphone 110 is taken as an exemplary private user, and the user of desktop computer 140 is taken as an exemplary public user (i.e., public account). In one implementation, the server 160 may be a WeChat server. It should be noted that, the method is also applicable for other instant messaging tools.

As shown in FIG. 3, the method includes the following operations.

At block 301, the smartphone 110 of the private user determines whether the private user opens a conversation window between the private user and a public user. If the private user opens a conversation window with a public user, block 302 is performed; otherwise, block 301 is repeated to determine whether the private user opens a conversation window with a public user.

In this block, the method for determining whether a conversation window between the private user and the public user is opened may be well known for those skilled in the art, thus is not described herein.

At block 302, the smartphone 110 notifies the server 160 that the private user has opened the conversation window with the public user.

In this block, the smartphone 110 may automatically generates a message and transmits the message to the server 160, so as to notify the server 160 that the private user has opened a conversation window with the public user. In one implementation, the message may include a message type, a private user ID, a public user ID and message content, wherein the message content is used for notifying the server 160 that the conversation window between the private user and the public user is opened. In this example, the private user ID is the ID of the private user of the smartphone 110, and the public user ID is the ID of the public user of desktop computer 140. It should be noted that the message may further include other elements which are not restricted in the present disclosure.

At block 303, after being notified, the server 160 determines whether the public user has a real-time response ability. If the public user has the real-time response ability, block 304 is performed; otherwise, the method ends.

In this block, the real-time response ability means that the public user is capable of sending corresponding messages or providing particular services to the private user in response to knowing the opening of the conversation window between the private user and the public user.

In one implementation, the public user may indicate whether he has the real-time response ability when he registers on the server 160 through the public platform. For example, information indicating whether the public user has the real-time response ability may be recorded in profile data of the public user in the server 160. Thus, the server 160 may determine, after receiving the message transmitted by the smartphone 110, whether the public user has the real-time response ability according to the profile data of the public user.

At block 304, the server 160 notifies the public user of the event that the private user has opened a conversation window with the public user, such that the public user may take an appropriate action, e.g., send a message to the private user.

The server 160 may notify the public user of the event of the opening of the conversation window through various manners. For example, the server 160 may display a prompt message in an operating interface of the public user, prompting the public user that the private user has opened a conversation window with him. Preferably, the displayed message may include the name or ID of the private user. In a practical application, the server 160 may also play a sound to the public user. Those skilled in the art may have various manners to prompt the public user of the event. The variations should also be included in the protection scope of the present disclosure.

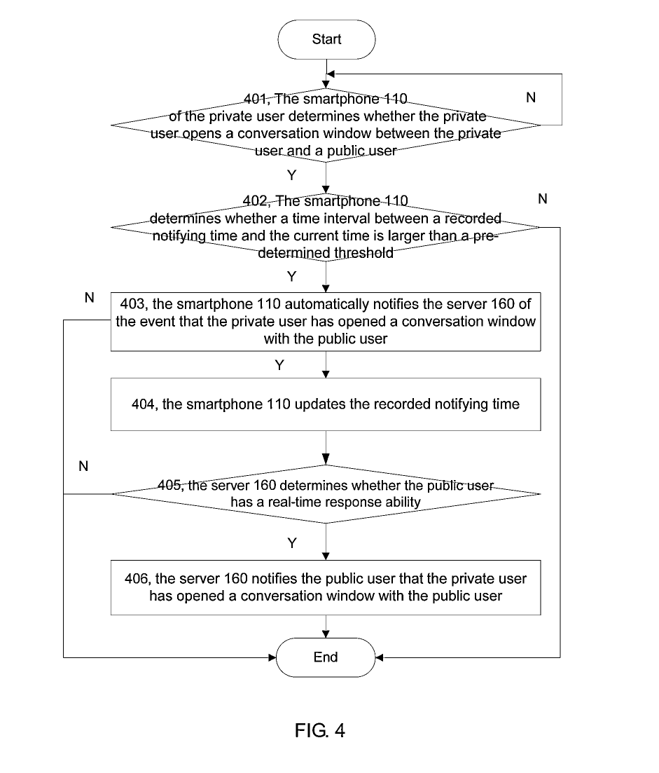

FIG. 4 is a schematic diagram illustrating a method for notifying a public user in instant messaging in accordance with an example of the present disclosure. In the procedure of FIG. 4, each time the smartphone 110 notifies the server 160 of the event of the opening of the conversation window, a notifying time may be recorded in the smartphone 110. Thus, before the smartphone 110 notifies the server 160 in block 302, the smartphone 110 may determine whether a time interval between the recorded notifying time and the current time is larger than a pre-determined threshold. If the time interval between the recorded notifying time and the current time is larger than the pre-determined threshold, the smartphone 110 notifies the server 160; otherwise, the smartphone 110 does not notify the server 160. Thus, if the private user opens conversation windows with the same public user frequently, the public user will be prompted for only one time, thus will not be disturbed by the frequently displayed prompt messages. In addition, radio resources are also saved.

In this example, a notifying time needs to be configured in the smartphone 110. The notifying time may be stored in the smartphone 110 in association with the ID/name of the public user. A default initial value may be configured for the notifying time. For example, the default initial value may be configured as a time earlier than the private user adds the public user into a buddy list of the private user.

As shown in FIG. 4, the method includes the following operations.

At block 401, the smartphone 110 of the private user determines whether the private user opens a conversation window between the private user and a public user. If the private user opens a conversation window with a public user, block 402 is performed; otherwise, block 401 is repeated to determine whether the private user opens a conversation window with a public user.

At block 402, the smartphone 110 determines whether a time interval between a recorded notifying time and the current time is larger than a pre-determined threshold. If the time interval is larger than the pre-determined threshold, block 403 is performed; otherwise, the method ends.

In this example, if the smartphone 110 finds that the value of the notifying time is default initial value, the server 160 may determine that it is the first time that the private user opens a conversation window with the public user, i.e., the public user has not been notified before. Therefore, the smartphone 110 may generate and transmit a message to the server 160, so as to prompt the public user that the private user has opened a conversation window.

If the smartphone 110 finds that the value of the notifying time recorded in the smartphone 110 is not the default initial value, it indicates that the public user has been notified before. In this case, the smartphone 110 calculates a time interval between the recorded notifying time and the current time, and compares the time interval with the pre-determined threshold.

Alternatively, the smartphone 110 may also directly compare the recorded notifying time and the current time without determining whether the recorded notifying time equals to the default initial value.

In a practical application, the pre-determined threshold may be configured by the public user. Alternatively, the pre-determined threshold may be configured by an administrator of the server 160.

At block 403, the smartphone 110 automatically notifies the server 160 of the event that the private user has opened a conversation window with the public user.

This block is similar to block 302 in FIG. 3 and will not be repeated herein.

At block 404, the smartphone 110 updates the recorded notifying time.

In this block, the smartphone 110 may update the recorded notifying time to the current time. In a practical application, blocks 403 and 404 may be executed simultaneously or in any sequence.

At block 405, after being notified by the smartphone 110, the server 160 determines whether the public user has a real-time response ability. If the public user has the real-time response ability, block 405 is performed; otherwise, the method ends.

This block is similar to block 303 in FIG. 3 and will not be repeated herein.

At block 406, the server 160 notifies the public user that the private user has opened a conversation window with the public user, such that the public user may take an appropriate action, e.g., send a message to the private user.

This block is similar to block 304 in FIG. 3 and will not be repeated herein.

Now, the procedure shown in FIG. 4 ends. In the procedure of FIG. 4, the time interval is compared with the pre-determined threshold by the smartphone 110. In a practical application, the comparison may also be performed by the server 160, i.e., after being notified by the smartphone 110, the server 160 may firstly compare the time interval with the pre-determined threshold and then determine whether the public user has the real-time response ability.

Besides notifying the public user of the opening of the conversation window, the server 160 may further provide geographic location information of the private user to the public user, such that the public user may provide better services to the private user.

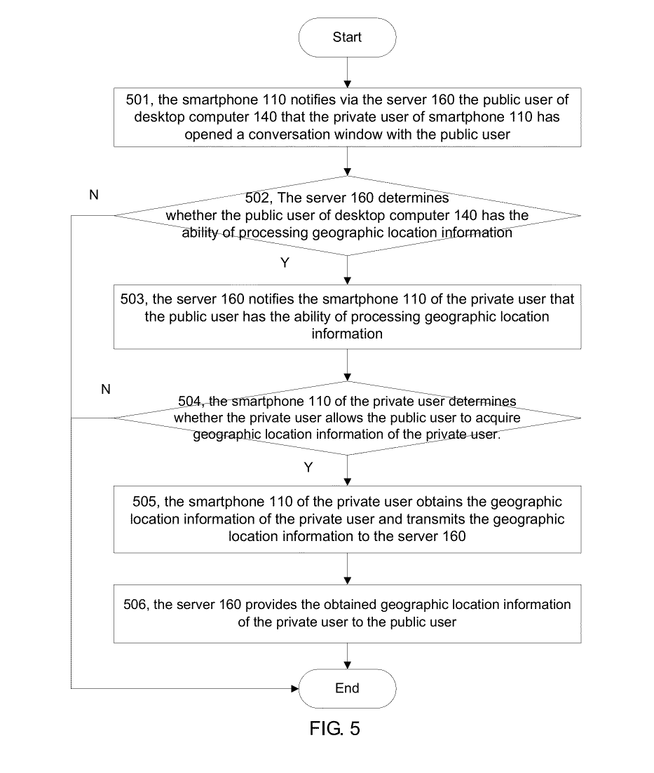

FIG. 5 is a schematic diagram illustrating a method for notifying a public user in instant messaging in accordance with an example of the present disclosure. In the procedure of FIG. 5, after the server 160 notifies the public user that the private user has opened a conversation window with the public user, the server 160 may determine whether the public user has an ability of processing geographic location information. If the public user has the ability of processing location information, the server 160 may notify the private user. Thereafter, the private user may obtain his geographic location information and provides the obtained geographic location information to the public user via the server 160.

As shown in FIG. 5, the method includes the following operations. In this example, the user of the smartphone 110 is still taken as an exemplary private user, and the user of the desktop computer 140 is still taken as an exemplary public user.

At block 501, the smartphone 110 notifies via the server 160 the public user of desktop computer 140 that the private user of smartphone 110 has opened a conversation window with the public user.

This block may involve the procedures described above in blocks 201-202, 301-303 and 401-405. The detailed procedure has been described above with reference to FIG. 2 to FIG. 4 and will not be repeated herein.

At block 502, the server 160 determines whether the public user of desktop computer 140 has the ability of processing geographic location information. If the public user has the ability of processing geographic location information, block 503 is performed; otherwise, the method ends.

The ability of processing geographic location information means that the public user is capable of sending corresponding messages or providing particular services to the private user in response to the geographic location information of the private user. In this example, the public user may indicate whether he has this ability when he registers on the server 160 through the public platform. In one implementation, information indicating whether the public user has the ability of processing geographic location information may be recorded in profile data of the public user in the server 160. Thus, the server 160 may determine whether the public user has the ability of processing geographic location information according to the profile data of the public user.

At block 503, the server 160 notifies the smartphone 110 of the private user that the public user has the ability of processing geographic location information.

At block 504, the smartphone 110 of the private user determines whether the private user allows the public user to acquire geographic location information of the private user. If the private user allows the public user to acquire the geographic location information of the private user, block 505 is performed; otherwise, the method ends.

In one implementation, if it is the first time that the private user opens the conversation window with the public user, the smartphone 110 may display a prompt dialog to the private user asking the private user whether he allows the public user to acquire the geographic location information of the private user. Typically, the prompt dialog may include two buttons “allow” and “not allow”. Once the private user clicks a button, the smartphone 110 may know whether the private user allows the public user to acquire the geographic location information or not.

After the private user clicks the button in the prompt dialog, the smartphone 110 of the private user may record a status of allowance in the smartphone 110. In one example, the status of allowance may be recorded in association with the ID of the public user. And the status may include allow and forbid. As such, the smartphone 110 does not need to ask the private user each time.

When the private user opens the conversation window with the public user the next time, the smartphone 110 of the private user may determine whether the private user allows the public user to acquire his geographic location information according to the recorded status, and may automatically obtain and report the geographic location information of the private user if the status indicates that the private user allows the public user to acquire the geographic location information of the private user.

At block 505, the smartphone 110 of the private user obtains the geographic location information of the private user and transmits the geographic location information to the server 160.

In various examples of the present disclosure, the geographic location information may be longitude and latitude information, or an IP address, or an address (such as name of a building) of the private user.

There may be several manners for the smartphone 110 to obtain the geographic location information of the private user.

In a first manner, the smartphone 110 may obtain the geographic location information of the private user using Wi-Fi. In this manner, the obtained geographic location information may be an IP address of the private user. In this case, the IP address may be converted into longitude and latitude information. The detailed conversion procedure is known for those skilled in the art and will not be repeated herein. In a second manner, the smartphone 110 may obtain the geographic location information of the private user through a base station of a cellular network. In a third manner, the smartphone 110 may obtain the geographic location information of the private user through Global Positioning System (GPS).

Detailed processes of obtaining the geographic location information according to the above manners are well known for those skilled in the art and will not be repeated herein.

Preferably, the smartphone 110 may obtain the geographic location information of the private user using Wi-Fi. If Wi-Fi is not available, the geographic location information of the private user may be obtained using the cellular base station, i.e., the manner of obtaining through a base station is less preferable. In one implementation, the manner of GPS is the least preferable.

At block 506, the server 160 provides the obtained geographic location information of the private user to the public user.

Thereinafter, the public user may return a message or providing a corresponding service to the private user according to the geographic location information of the private user.

For example, if the public user determines that the private user is near to a shop of the public user, the public user may transmit a discount voucher to the private user.

In block 505 in FIG. 5, the geographic location information is obtained and transmitted to the server 160 for one time when the conversation window is opened. In another implementation, the geographic location information may be obtained and transmitted periodically after the conversation window is opened.

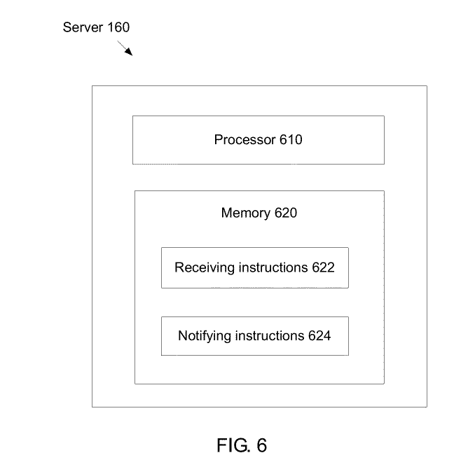

In accordance with the above method, various examples of the present disclosure further provide a server 160 for notifying a public user in instant messaging. FIG. 6 is a schematic diagram illustrating a server 160 for notifying a public user in instant messaging in accordance with an example of the present disclosure.

As shown in FIG. 6, the server 160 may include at least one Central Processing Unit (CPU) or a processor 610 and a memory 620. Note that the server 160 may further include an input/output interface, a network interface, a display interface and so on. Various modifications, additions or deletions may be made to the server 160 illustrated in FIG. 6 within the scope of the present disclosure.

Processor 610 performs computation and control functions of server 160. Processor 610 may include a single integrated circuit, such as a microprocessor, or may include any suitable number of integrated circuit devices and/or circuit boards working in cooperation to accomplish the functions of a processor or a CPU. The processor 610 is configured to execute one or more software programs contained in the memory 620.

The memory 620 includes:

receiving instructions 622, for receiving a notification from a client device of a private user, wherein the notification indicates that the private user opens a conversation window with a public user; and

notifying instructions 624, for notifying the public user that the private user opens the conversation window with the public user after the receiving instructions 622 receive the notification.

The memory 620 may further include instruction for:

determining whether the public user has a real-time response ability after receiving the notification and before notifying the public user; and

performing the operation of notifying the public user that the private user opens the conversation window with the public user if it is determined that the public user has the real-time response ability.

The memory 620 may further include instruction for:

determining whether the public user has an ability of processing geographic location information after notifying the public user that the private user opens the conversation window;

notifying the client device of the private user if the public user has the ability of processing geographic location information;

receiving geographic location information transmitted by the client device of the private user; and

providing the geographic location information to the public user

The memory 620 may further store data and programs such as an operating system and one or more application programs.

Detailed functions of the server 160 have been described above with reference to the procedure as shown in FIG. 2 to FIG. 5 and will not be repeated herein.

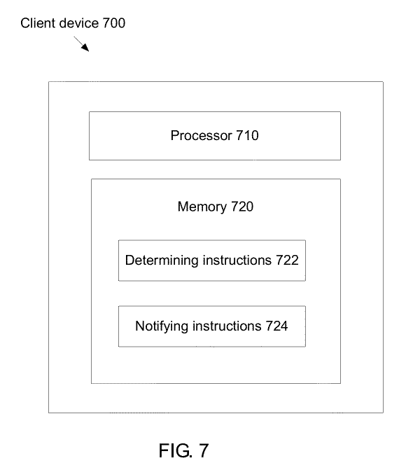

In accordance with the above method, various examples of the present disclosure further provide a client device of a private user for notifying a public user in instant messaging. FIG. 7 is a schematic diagram illustrating a client device 700 for notifying a public user in instant messaging in accordance with an example of the present disclosure.

As shown in FIG. 7, the client device 700 of the private user may include at least one Central Processing Unit (CPU) or a processor 710 and a memory 720. Note that the client device 700 of the private user may further include an input/output interface, a network interface, a display interface and so on. Various modifications, additions or deletions may be made to the client device 700 illustrated in FIG. 7 within the scope of the present disclosure.

Processor 710 performs computation and control functions of client device 700. Processor 710 may include a single integrated circuit, such as a microprocessor, or may include any suitable number of integrated circuit devices and/or circuit boards working in cooperation to accomplish the functions of a processor or a CPU. The processor 710 is configured to execute one or more software programs contained in the memory 720.

The memory 720 includes:

determining instructions 722 for determining whether a conversation window is opened between a private user of the client device 700 and a public user; and

notifying instructions 724 for notifying an IM server that the private user opens the conversation window with the public user if the determining instructions 722 determine that the private user of the client device 700 opens the conversation window with the public user, such that the IM server notifies the public user that the private user opens the conversation window with the public user.

The memory 720 may further include instructions for recording a notifying time of notifying the IM server after notifying the IM server that the private user opens the conversation window between the private user and the public user.

The determining instructions 722 may further involves instructions for determining whether a time interval between the recorded notifying time and a current time is larger than a pre-determined threshold before notifying the IM server that the private user opens the conversation window, and performing the operation of notifying the IM server if the time interval is larger than the pre-determined threshold.

The memory 720 may further include instructions for determining whether the private user allows the public user to acquire geographic location information of the private user after being notified that the public user has an ability of processing geographic location information; obtaining the geographic location information of the private user; and transmitting the geographic location information to the IM server.

In various examples of the present disclosure, the geographic location information of the private user may be transmitted to the IM server periodically. And the geographic location information of the private user is obtained using Wi-Fi, or a cellular base station or Global Positioning System (GPS).

The memory 720 may store data and programs such as an operating system and one or more application programs.

In various examples of the present invention, the IM application may include WeChat, QQ, ICQ, MSN Messenger, Skype, Fetion, AIM, GoogleTalk, MyspaceIM, Sametime, Gadu Gadu, etc. Accordingly, the network computer system 100 may be a system implementing any one of the above listed IM applications.

As will be appreciated by one skilled in the art, aspects of the disclosed network computer system 100 disclosed herein may be embodied as a system, method or computer program product. Accordingly, aspects of the network computer system may take the form of an hardware embodiment, an software embodiment or an embodiment combining software and hardware aspects that may all generally be referred to herein as a “circuit”, “module” or “system”. Furthermore, aspects of the network computer system may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), a digital versatile disk (DVD), an erasable programmable read-only memory (EPROM or Flash memory), an optical fiber, a portable compact disc read-only memory (CD-ROM), an optical storage device, a magnetic storage device, or any tangible medium that can contain, or store a program for use by or in connection with an instruction execution system, apparatus, or device.

What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

What is claimed is:

1. A computer-implemented method for notifying a public user in instant messaging (IM), comprising:
determining, by a client device of a private user, whether a conversation window is opened between the private user and a public user; and
if the conversation window between the private user and public user is opened, notifying, by the client device of the private user, an IM server that the private user opens the conversation window with the public user, such that the IM server notifies the public user that the private user opens the conversation window with the public user.

2. The computer-implemented method of claim 1, further comprising:
after notifying the IM server that the private user opens the conversation window between the private user and the public user, recording, by the client device of the private user, a notifying time that the client device notifies the IM server.

3. The computer-implemented method of claim 2, further comprising:
before notifying the IM server that the private user opens the conversation window, determining, by the client device of the private user, whether a time interval between the recorded notifying time and a current time is larger than a pre-determined threshold; and
if the time interval is larger than the pre-determined threshold, performing the operation of notifying the IM server that the private user opens the conversation window.

4. The computer-implemented method of claim 1, further comprising:
if the public user has an ability of processing geographic location information, obtaining, by the client device of the private user, geographic location information of the private user if the private user allows the public user to acquire the geographic location information of the private user;
transmitting the geographic location information to the IM server such that the IM server provides the geographic location information of the private user to the public user.

5. The computer-implemented method of claim 4, wherein the geographic location information of the private user is transmitted to the IM server periodically.

6. The computer-implemented method of claim 4, wherein the geographic location information of the private user is obtained using at least one of Wi-Fi, a cellular base station and Global Positioning System (GPS).

7. A computer-implemented method for notifying a public user in instant messaging (IM), comprising:
receiving, by an IM server, a notification from a client device of a private user, wherein the notification indicates that the private user opens a conversation window with a public user; and
after receiving the notification, notifying, by the IM server, the public user that the private user opens the conversation window with the public user.

8. The computer-implemented method of claim 7, further comprising:
after receiving the notification and before notifying the public user, determining, by the IM server, whether the public user has a real-time response ability; and
performing the operation of notifying the public user that the private user opens the conversation window with the public user if it is determined that the public user has the real-time response ability.

9. The computer-implemented method of claim 7, further comprising:
after notifying the public user that the private user opens the conversation window, determining, by the IM server, whether the public user has an ability of processing geographic location information;
notifying the client device of the private user if the public user has the ability of processing geographic location information;
receiving geographic location information transmitted by the client device of the private user; and
providing the geographic location information to the public user.

10. A client device of a private user in instant messaging (IM), comprising a processor and a memory coupled to the processor, wherein the memory comprises machine readable instructions executable by the processor to:
determine whether a conversation window is opened between the private user and a public user; and
if the conversation window between the private user and public user is opened, notify an IM server that the private user opens the conversation window with the public user, such that the IM server notifies the public user that the private user opens the conversation window with the public user.

11. The client device of claim 10, wherein the memory further comprises machine readable instructions executable by the processor to:
record a notifying time that the client device notifies the IM server after notifying the IM server that the private user opens the conversation window between the private user and the public user.

12. The client device of claim 11, wherein the memory further comprises machine readable instructions executable by the processor to:
determine, before notifying the IM server that the private user opens the conversation window, whether a time interval between the recorded notifying time and a current time is larger than a pre-determined threshold; and
perform the operation of notifying the IM server that the private user opens the conversation window if the time interval is larger than the pre-determined threshold.

13. The client device of claim 10, wherein the memory further comprises machine readable instructions executable by the processor to:
obtain geographic location information of the private user if the private user allows the public user to acquire the geographic location information of the private user and if the public user has an ability of processing geographic location information; and
transmit the geographic location information to the IM server such that the IM server provides the geographic location information of the private user to the public user.

14. The client device of claim 13, wherein the memory further comprises machine readable instructions executable by the processor to obtain the geographic location information of the private user and transmit the geographic location information to the IM server periodically.

15. A non-transitory computer-readable storage medium storing one or more programs, which when being executed by a processor, perform the steps of:
determining whether a conversation window is opened between the private user and a public user; and
if the conversation window between the private user and public user is opened, notifying an IM server that the private user opens the conversation window with the public user, such that the IM server notifies the public user that the private user opens the conversation window with the public user.

16. The non-transitory computer-readable storage medium of claim 15, further comprising instructions for:
recording a notifying time of notifying the IM server after notifying the IM server that the private user opens the conversation window between the private user and the public user.

17. The non-transitory computer-readable storage medium of claim 16, further comprising instructions for:
determining whether a time interval between the recorded notifying time and a current time is larger than a pre-determined threshold before notifying the IM server that the private user opens the conversation window; and
performing the operation of notifying the IM server that the private user opens the conversation window if the time interval is larger than the pre-determined threshold.

18. The non-transitory computer-readable storage medium of claim 15, further comprising instructions for:
determining whether the private user allows the public user to acquire geographic location information of the private user after being notified that the public user has an ability of processing geographic location information;
obtaining the geographic location information of the private user; and
transmitting the geographic location information to the IM server.

19. The non-transitory computer-readable storage medium of claim 18, wherein the geographic location information of the private user is transmitted to the IM server periodically.

20. The non-transitory computer-readable storage medium of claim 18, wherein the geographic location information of the private user is obtained using Wi-Fi, or a cellular base station or Global Positioning System (GPS).
